(19) United States
(12) Patent Application Publication
(10) Pub. No.: US 2003/0127384 A1
(43) Pub. Date: Jul. 10, 2003

(54) Filter module for aircraft lubrication systems

(76) Inventor: Desh Kapur, Elyria, OH (US)

Correspondence Address: Donald L. Otto, Renner, Otto, Boisselle & Sklar, LLP, 1621 Euclid Avenue, 19th Floor, Cleveland, OH, 44115-2191, US

(21) Appl. No.: 10/042,893

(22) Filed: Jan. 9, 2002

(51) Int. Cl. B01D 27/00

(52) U.S. Cl. 210/235; 210/416.5

(57) ABSTRACT

A filter module for aircraft lubrication systems includes a replaceable filter assembly, an integrated differential pressure actuated bypass valve and a service shut-off valve in a single line replaceable unit. Such a filter module can also be incorporated into an aircraft lube and scavenge pump assembly.

### FIELD OF THE INVENTION

This invention relates generally to a filter module that incorporates various functions of an aircraft lubrication filtration system in a single line replaceable unit.

### BACKGROUND OF THE INVENTION

Both commercial and military aircraft require a lubrication filtration system to lubricate various aircraft engine parts including for example engine bearings and gear boxes and the like. Heretofore such systems were comprised of several individual components that had to be serviced and, if needed, replaced.

### SUMMARY OF THE INVENTION

The present invention combines multiple lubrication filtration system functions into a single unit, making it easier to service or replace if needed.

In accordance with one aspect of the invention, a filter module is provided that incorporates a replaceable filter assembly, an integrated differential pressure actuated bypass valve and a service shut-off valve in a single line replaceable unit.

In accordance with another aspect of the invention, the filter module allows for removal of the filter assembly without drain down of the lubrication fluid inlet line attached to the module.

In accordance with another aspect of the invention, the filter module allows for removal of the filter assembly without drain down of the lubrication fluid discharge line attached to the module.

In accordance with another aspect of the invention, the filter module includes a visual impending bypass indicator that provides a visual indication when the filter assembly requires cleaning or replacement.

In accordance with another aspect of the invention, the filter module has flow bypass capability allowing flow from the module inlet to the module outlet in the event the filter assembly becomes plugged or clogged with debris.

In accordance with another aspect of the invention, the filter module allows for drain down of the entire system without having to remove the filter assembly.

In accordance with another aspect of the invention, the filter module can be incorporated into an aircraft lube and scavenge pump assembly.

These and other objects, advantages, features and aspects of the present invention will become apparent as the following description proceeds.

To the accomplishment of the foregoing and related ends, the invention, then, comprises the features hereinafter more fully described and particularly pointed out in the claims, the following description and the annexed drawings setting forth in detail certain illustrative embodiments of the invention, these being indicative, however, of but several of the various ways in which the principles of the invention may be employed.

### BRIEF DESCRIPTION OF THE DRAWINGS

In the annexed drawings:

FIG. 1 is a longitudinal section through one form of filter module in accordance with the present invention which includes a replaceable filter assembly, an integrated differential pressure actuated bypass valve, a service shut-off valve and a visual impending bypass indicator in a single unit, showing normal fluid flow from the module inlet through the filter assembly and then out the module outlet;

FIG. 2 is a longitudinal section through the filter module similar to FIG. 1 but showing the visual impending bypass indicator extended to indicate that the filter assembly needs to be cleaned or replaced, and the bypass valve in the open position allowing fluid flow from the module inlet to the module outlet to bypass the filter assembly;

FIG. 3 is a longitudinal section through the filter module similar to FIG. 1 but showing the filter assembly removed from the unit and the service shut-off valve in the closed position preventing drain down of the inlet line attached to the filter module during filter assembly removal;

FIG. 3A is a longitudinal section through a modified form of filter module similar to that shown in FIG. 3 but also including a discharge check valve preventing drain down of the discharge line attached to the filter module during filter assembly removal; and

FIG. 4 is a longitudinal section through another embodiment of the invention in which the various components of the filter module of the present invention are incorporated into an aircraft lube and scavenge pump assembly.

### DETAILED DESCRIPTION OF THE INVENTION

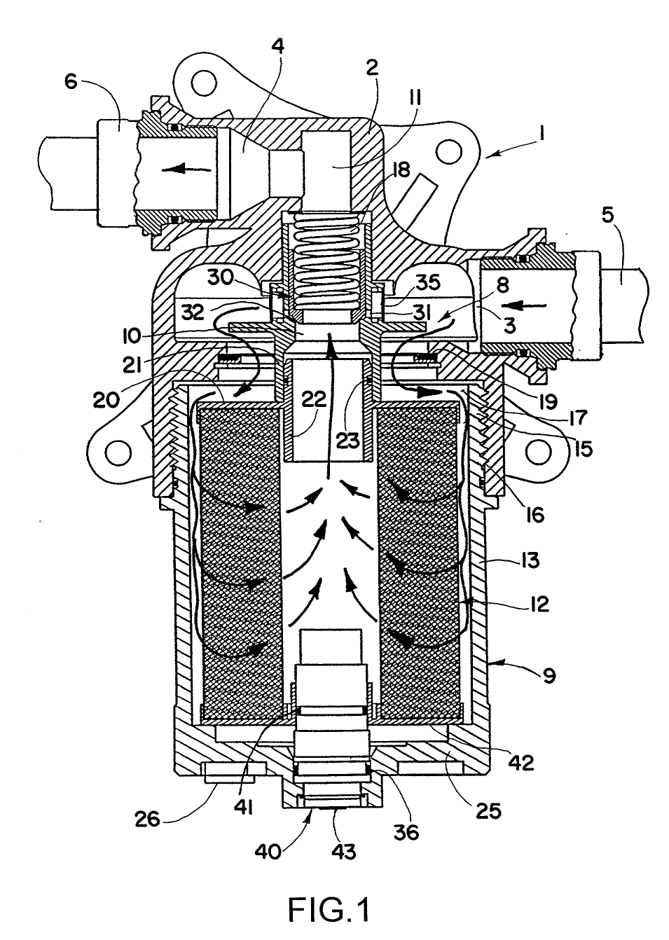

Referring now in detail to the drawings, and initially to FIG. 1, there is shown one form of filter module 1 in accordance with this invention that combines multiple aircraft lubrication filtration system functions in one line replaceable unit as described hereafter. The housing 2 of filter module 1 contains a fluid inlet 3 and fluid outlet 4 to which respective lubricator inlet and discharge lines 5 and 6 are connected. Within housing 2 are two separate flow paths between the fluid inlet and outlet. The primary flow path is through a service shut-off valve 8 which when moved to the open position shown in FIG. 1 allows fluid flow from the fluid inlet 4 through a replaceable filter assembly 9 and central passage 10 through service shut-off valve 8 communicating with fluid outlet 4 through fluid passage 11 in housing 2.

Filter assembly 9 includes a filter element 12 contained within a filter cover 13 that has an externally threaded outer open end 15 for threaded engagement within an internally threaded bore 16 in filter module housing 2 providing a filter chamber 17 downstream of shut-off valve 8.

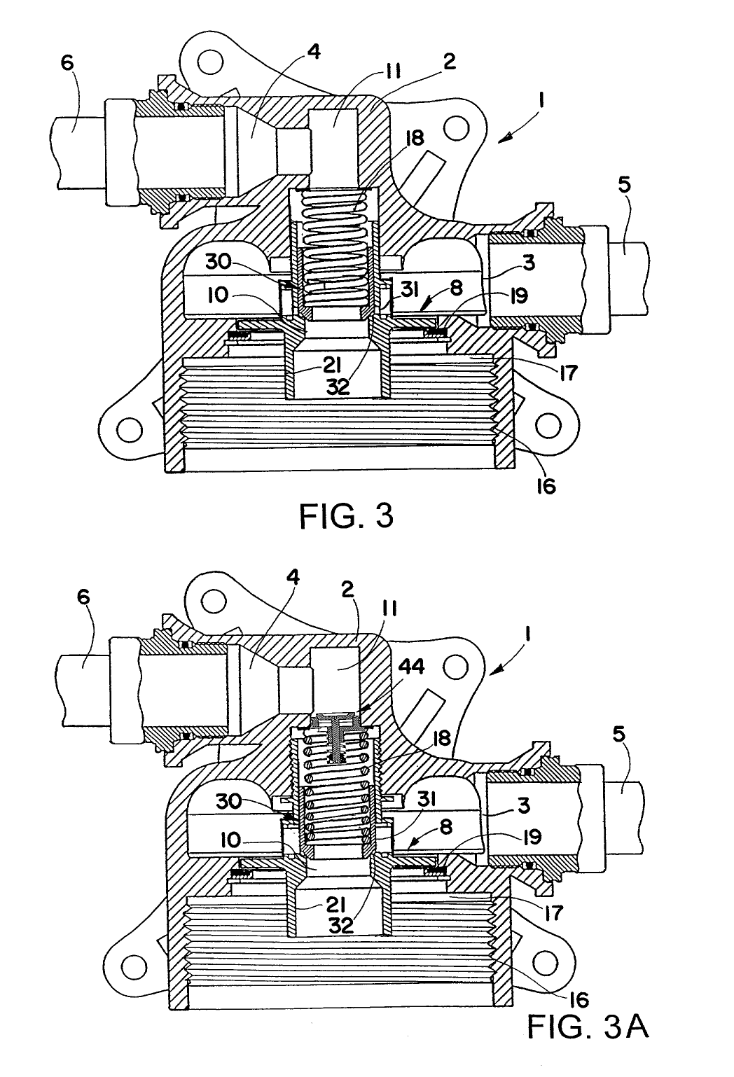

When filter assembly 9 is unscrewed from threaded bore 16, a spring 18 within filter module housing 2 urges service shut-off valve 8 into seated engagement with a service shut-off valve seal 19 blocking fluid communication between fluid inlet 3 and filter chamber 17 as schematically shown in FIG. 3.

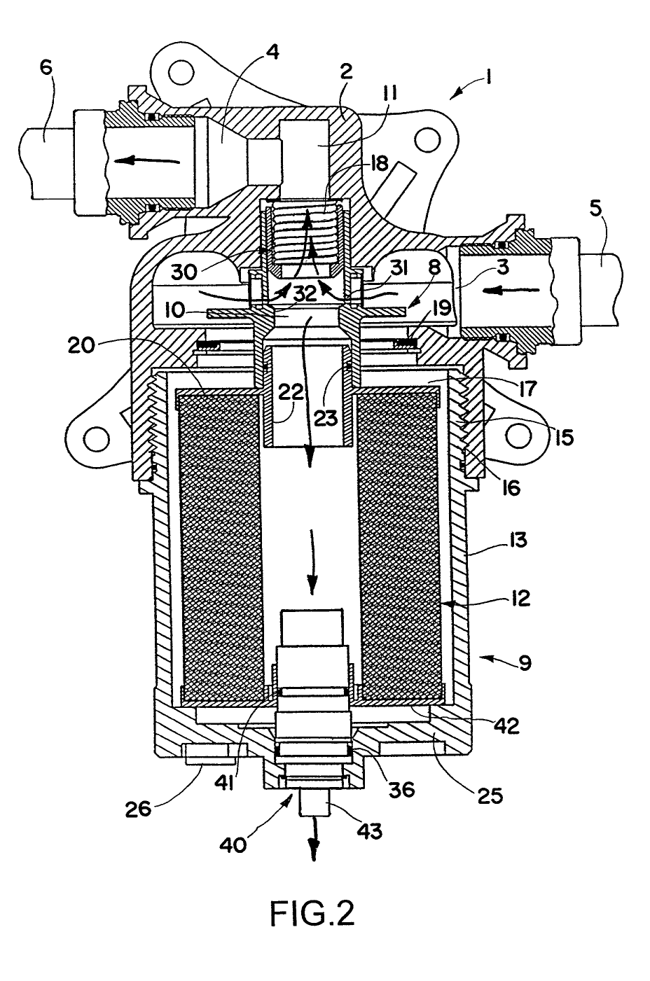

Conversely, as filter assembly 9 is screwed into bore 16, a ring shaped end cap 20 on the inner end of filter element 12 engages an axially outwardly extending tubular extension 21 on service shut-off valve 8, forcing service shut-off valve 8 axially inwardly to the open position shown in FIGS. 1 and 2. End cap 20 has a central hub portion 22 surrounded by an O-ring seal 23 that is slidably received within tubular extension 21 of service shut-off valve 8 during screwing of filter assembly 9 into bore 16 to form a fluid tight seal therebetween.

During normal operation, any debris within the fluid passing through filter module 1 will be filtered out by filter element 12 before exiting the filter module through discharge line 6 attached to fluid outlet 4. At the closed outer end 25 of filter cover 13 is a drain plug 26 which when removed allows drain down of the entire system without having to remove the filter assembly 9 from the filter module 1.

If at any time during operation the filter assembly 9 becomes plugged with debris restricting fluid flow through the filter assembly, the differential pressure across service shut-off valve 8 will increase. This differential pressure acts on a bypass valve 30 slidably received within central passage 10 of service shut-off valve 8 through radial ports 31 in service shut-off valve 8. Bypass valve 30 is downstream of service shut-off valve seal 19 and is normally maintained in sealing engagement with a valve seat 32 within central passage 10 by spring 18, blocking flow through bypass valve 30. However, when the differential pressure increases to a predetermined level, the differential pressure acting on bypass valve 30 will cause bypass valve 30 to move out of engagement with its seat 32 allowing fluid flow from inlet 3 to outlet 4 through bypass valve 30 bypassing filter assembly 9. A bypass passage screen 35 may surround bypass ports 31 to provide limited screening of any debris from the fluid passing through bypass valve 30.

Mounted within a sealed opening 36 in the closed outer end 25 of filter cover 13 is a visual impending bypass indicator pressure switch 40 of conventional type. When the filter element 12 is first inserted into the filter cover 13, it forms a fluid seal with the bypass indicator 40 which extends axially inwardly through a sealed opening 41 in the outer end cap 42 of filter element 12 into the interior of filter element 12, exposing bypass indicator 40 to the differential pressure across filter element 12. When this differential pressure reaches a predetermined high level, a button 43 on the outer end of bypass indicator 40 pops out as schematically shown in FIG. 2 providing a visual indication that the filter assembly 9 needs to be cleaned or replaced. This button 43 will remain extended until it is manually reset by a technician.

To clean or replace the filter assembly 9, filter assembly 9 is removed from filter module 1 by unscrewing filter cover 13 from filter module bore 16. As the filter cover 13 is unscrewed, the force of spring 18 acting on shut-off valve 8 causes shut-off valve 8 to close against valve seal 19 prior to disengagement of the filter cover threads from the mating filter module bore threads, thus allowing removal of the filter assembly 9 without drain down of the lube tank (not shown) through inlet line 5 attached to the filter module inlet 3. Depending on the lube tank location, which is upstream of the filter module inlet 3 and may either be lower or higher than the lube pump, this inlet check function may be critical in preventing lube tank drain down during filter removal.

Likewise, if the various parts being lubricated downstream of the filter module outlet 4 are higher than the filter module, a discharge check valve 44 is provided in fluid passage 11 of filter module 1 as schematically shown in FIG. 3A, preventing drain down of the discharge line 6 during filter removal. Otherwise the filter module 1 shown in FIG. 3A is substantially the same as that shown in the other figures.

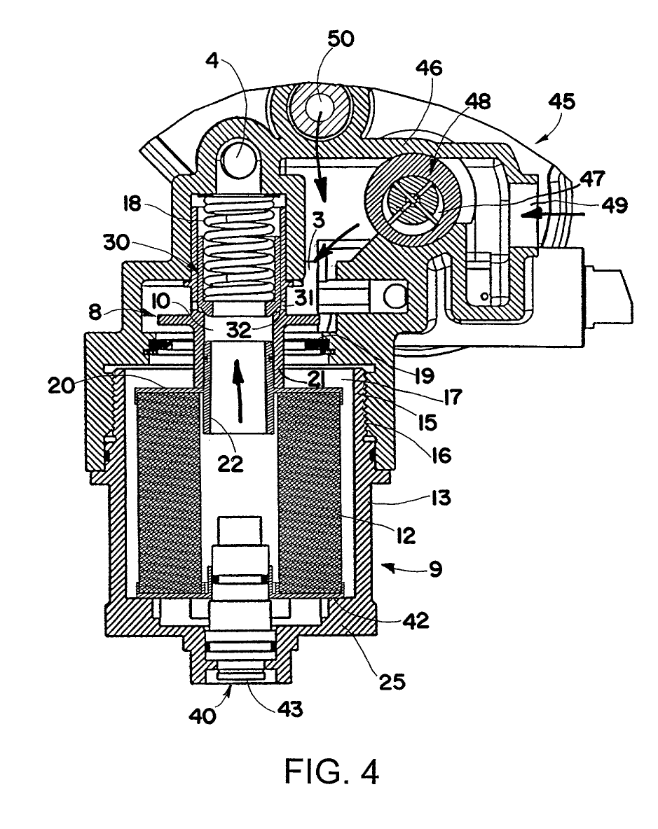

Filter module 1 shown in FIGS. 1-3 and 3A is designed to be incorporated into an aircraft lubrication filtration system as a single line replaceable unit. However, such a filter module can also be integrated into an aircraft lubrication and scavenge pump assembly 45 by making the filter module housing an integral part of the lube and scavenge pump assembly housing 46 as schematically shown in FIG. 4. In this embodiment, the common filter/pump housing 46 also contains a pump chamber 47 in which a vane type pumping element 48 is rotatably mounted. Pumping element 48 is driven through a suitable drive coupling between the pumping element and an associated gear box inside the aircraft engine (not shown). As the pumping element 48 is rotated, lubricant from the lube tank (not shown) is drawn into the pump chamber 47 through the pump inlet 49 and discharged into the filter inlet 3 for flow through filter shut-off valve 8 and filter assembly 9 and out filter discharge outlet 4 in the manner previously described.

Although the invention has been shown and described with respect to certain embodiments, it is obvious that equivalent alterations and modifications will occur to others skilled in the art upon the reading and understanding of the specification. In particular, with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed component which performs the function in the herein exemplary embodiments of the invention. In addition, while a particular feature of the invention may have been disclosed with respect to only one embodiment, such feature may be combined with one or more other features of other embodiments as may be desired and advantageous for any given or particular application.

What is claimed is:

1. A filter module for aircraft lubrication systems comprising a housing containing a filter inlet and a discharge outlet, a filter chamber within said housing, a filter assembly removably attachable to said filter chamber, a shut-off valve within said housing which is moved to an open position providing fluid communication between said inlet and said outlet through said filter chamber when said filter assembly is inserted into said filter chamber, a spring for moving said shut-off valve to a closed position blocking fluid communication between said inlet and said filter chamber when said filter assembly is removed from said filter chamber, and a bypass valve within said housing for providing fluid communication between said inlet and said outlet whenever a differential pressure across said bypass valve reaches a predetermined high level.

2. The filter module of claim 1 wherein said shut-off valve is moved into the closed position by said spring before said filter assembly is completely removed from said filter chamber.

3. The filter module of claim 1 wherein said filter assembly is threadedly connectable to said filter chamber.

4. The filter module of claim 1 wherein said filter assembly comprises a filter cover containing a filter element having an end cap at one end that is engageable with said shut-off valve during insertion of said filter assembly into said filter chamber to cause said shut-off valve to move to the open position.

5. The filter module of claim 4 wherein said shut-off valve has a central passage providing fluid communication between said outlet and said filter chamber through said shut-off valve.

6. The filter module of claim 5 wherein said end cap includes a central hub portion in sealed engagement with a tubular extension on said shut-off valve when said filter assembly is attached to said filter chamber.

7. The filter module of claim 6 wherein said bypass valve is axially movable into and out of sealed engagement with a valve seat in said housing.

8. The filter module of claim 7 wherein said spring that biases said shut-off valve toward the closed position also biases said bypass valve into sealed engagement with said valve seat.

9. The filter module of claim 8 further comprising a bypass passage in said housing for providing fluid communication between said inlet and said outlet through said bypass valve when the differential pressure acting on said bypass valve reaches a predetermined high level causing said bypass valve to move out of engagement with said valve seat.

10. The filter module of claim 1 wherein said filter assembly comprises a filter cover containing a removable filter element and said filter chamber is formed by an internally threaded bore in said housing in which an externally threaded open end of said filter cover is threadedly connectable.

11. The filter module of claim 1 wherein said filter assembly includes a drain plug which is removable to allow drain down of fluid through said inlet without having to remove said filter assembly from said filter chamber.

12. The filter module of claim 1 wherein said filter assembly has a closed outer end, further comprising a visual impending bypass indicator mounted in a sealed opening in said closed outer end for providing a visual indication that said filter assembly needs to be cleaned or replaced.

13. The filter module of claim 12 wherein said visual indicator includes a button that pops out beyond the closed outer end of said filter assembly when the pressure across said filter element reaches a predetermined high level providing a visual indication that the filter assembly needs to be cleaned or replaced.

14. The filter module of claim 1 which comprises a single line replaceable filter module in an aircraft lubrication filtration system.

15. The filter module of claim 1 wherein said shut-off valve is closed prior to disengagement of said filter assembly from said filter chamber to prevent drain down of a lube tank attached to said inlet during filter assembly removal.

16. The filter module of claim 15 further comprising a discharge check valve in said housing for preventing drain down of a discharge line connected to said outlet during filter assembly removal.

17. The filter module of claim 1 further comprising a pump chamber in said housing and a pumping element in said pumping chamber for pumping fluid from a pump inlet to said filter inlet.

18. The filter module of claim 17 further comprising a lubrication return line in fluid communication with said filter inlet.

19. A filter module for aircraft lubrication systems comprising a housing having a filter inlet and a discharge outlet, a filter chamber, a filter assembly removably attachable to said filter chamber, a shut-off valve within said housing which is moved to an open position providing fluid communication between said inlet and said outlet through said filter assembly when said filter assembly is inserted into said filter chamber, a spring for maintaining said shut-off valve in a closed position blocking fluid communication between said inlet and said filter chamber when said filter assembly is removed from said filter chamber, and a bypass valve within said housing for providing bypass flow from said inlet to said outlet through said bypass valve whenever a differential pressure across said bypass valve reaches a predetermined high level, said inlet and said outlet being connectable to respective inlet and discharge lines of an aircraft lubrication system to provide a single line replaceable unit.

20. A lubrication and scavenge pump assembly comprising a housing containing a pump chamber, a pumping element in said pump chamber for pumping fluid from a pump inlet to a filter inlet within said housing, a filter chamber in said housing, a filter assembly removably attachable to said filter chamber, a shut-off valve in said housing which is moved to an open position providing fluid communication between said filter inlet and a discharge outlet in said housing through said filter assembly when said filter assembly is inserted into said filter chamber, a spring for maintaining said shut-off valve in a closed position blocking fluid communication between said filter inlet and said filter chamber when said filter assembly is removed from said filter chamber, and a bypass valve within said housing for providing fluid communication between said filter inlet and said discharge outlet through said bypass valve whenever a differential pressure across said bypass valve reaches a predetermined high level.

21. The pump assembly of claim 20 further comprising a lubrication return line in fluid communication with said filter inlet.
